(19) United States
(12) Patent Application Publication
(10) Pub. No.: US 2017/0200940 A1
(43) Pub. Date: Jul. 13, 2017

(54) NANNOPARTICLE/POROUS GRAPHENE COMPOSITE, SYNTHESIZING METHODS AND APPLICATIONS OF SAME

(71) Applicant: HK Graphene Technology Corporation, Pasadena, CA (US)

(72) Inventor: Jianguo Xu, Pasadena, CA (US)

(21) Appl. No.: 15/396,932

(22) Filed: Jan. 3, 2017

Related U.S. Application Data
(60) Provisional application No. 62/277,644, filed on Jan. 12, 2016.

(51) Int. Cl. H01M 4/36; H01M 4/587; H01M 4/485; H01G 11/50; H01M 4/38; C01G 23/00; C01G 49/06; C23C 18/16; H01M 10/0525; H01M 4/52

(52) U.S. Cl. CPC H01M 4/362; H01M 10/0525; H01M 4/587; H01M 4/485; H01M 4/523; H01M 4/38; C01B 31/0484; C01G 23/005; C01G 49/06; C23C 18/1644; C23C 18/1639; C23C 18/1694; H01G 11/50; H01M 2004/021

(57) ABSTRACT

In one aspect, the invention relates to a method of synthesizing a nannoparticle/porous graphene composite, including dispersing porous graphene structures into a solvent to form a dispersion of the porous graphene structures therein, adding precursors of nanoparticles into the dispersion of the porous graphene structures in the solvent to form a precursor mixture, and treating the precursor mixture to form a nannoparticle/porous graphene composite. The composite is formed such that the nanoparticles are uniformly distributed in pores of the graphene structures. The composite is very useful as electrode materials in electrochemical devices, in which efficient ions and electron transports are required.

### CROSS-REFERENCE TO RELATED PATENT APPLICATION

This application claims priority to and the benefit of, pursuant to 35 U.S.C. §119(e), U.S. Provisional Patent Application Ser. No. 62/277,644, filed Jan. 12, 2016, which is incorporated herein in its entirety by reference.

### FIELD

This invention relates generally to the field of nanotechnologies, and more particularly, to a method of loading active nanoparticles into nitrogen-doped mesoporous graphene fibers, and a resulted composite therefrom and applications of the same. The resulted composite has excellent electrochemical properties and great potential in wide applications, such as in lithium-ion batteries and supercapacitors.

### BACKGROUND

The background description provided herein is for the purpose of generally presenting the context of the present invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as the prior art against the present invention.

Nanocarbon and their composite materials have wide applications. They have been widely used in the field of electrochemical energy storage, such as in lithium-ion batteries (LIBs). Nowadays, lithium ion batteries are extending their applications to electric vehicles, large-scale power grids, and renewable energy storage systems. The developments of LIBs with higher energy/power densities and improved safety are very important for those applications. Graphite has been widely used as anode materials in the LIBs. However, the poor rate performance and safety concerns of graphite anodes have hampered the development of LIBs. Searching for high-power anode materials is thereby becoming one important theme in energy storages. Spinel Li₄Ti₅O₁₂ (LTO) has attracted great attention in recent years, owing to the advantages such as high stability in repeated lithium insertion/extraction reactions, the safe charge/discharge plateau, and the great potential for high-rate applications. However, LTO shows low electron conductivity and still limited ion diffusion rates, only offering limited rate performance.

To achieve better performance, carbon-modified composites of LTO have been prepared and highly improve the rate performance. However, for better rapid discharge rate, current performance of batteries is still limited by the big size of active materials. Reducing the size dimension of active materials is essential to realize better potentials. Although the formation of carbon nanotubes- and graphene-based LTO nanocomposites has emerged as effective methods to improve the battery performance, the strategies always suffer from dispersion and reassembly of nanocarbons, leading to difficult compounding of the composites. Accordingly, loading active materials onto nanocarbons and make the high-performance electrode materials remain a challenge.

Therefore, a heretofore unaddressed need exists in the art to address the aforementioned deficiencies and inadequacies.

### SUMMARY

In order to solve the aforementioned deficiencies and inadequacies, one of the objectives of this invention is to provide a preparation method to load nanoparticles into porous graphene structures and form a uniform nanoparticles/porous graphene composite. Another objective of this invention is to provide composite materials for high-performance electrode materials for energy storage.

In one aspect, the invention relates to a method of synthesizing a nannoparticle/porous graphene composite. In certain embodiments, the method include the steps of dispersing porous graphene structures into a solvent to form a dispersion of the porous graphene structures therein, adding precursors of nanoparticles into the dispersion of the porous graphene structures in the solvent to form a precursor mixture, and treating the precursor mixture to form a nannoparticle/porous graphene composite. In certain embodiments, the composite is formed such that the nanoparticles are uniformly distributed in pores of the graphene structures. The nanopartiles are in sizes of less than 10 nanometers.

In certain embodiment, the porous graphene structures comprise mesoporous graphene fibers, mesoporous graphene tubes, mesoporous graphene wires, or a combination of them. In certain embodiments, the mesoporous graphene fibers include nitrogen-doped graphene fibers.

In certain embodiments, the solvent comprises alcohol, water, or a combination of them. In certain embodiments, the solvent comprises ethanol, or ethylene glycol.

In certain embodiments, the precursors dissolved in the solvent are adsorbed into the pores of the graphene structures.

In certain embodiments, the precursors of the nanoparticles comprise metal oxides, metals, and/or inorganic compounds.

In certain embodiments, the nanoparticles comprise LTO, and the precursors of the LTO nanoparticles comprise lithium acetate, and tetra-n-butyltitanate added into the dispersion of the porous graphene structures. In certain embodiments, the treating step includes evaporating the solvent to form the dried powders, and annealing the dried powders to form the nannoparticle/porous graphene composite.

In certain embodiments, the nanoparticles comprise F₃O₄, and the precursors of the F₃O₄ nanoparticles comprise FeCl₃ and FeCl₂.4H₂O added into the dispersion of the porous graphene structures. In certain embodiments, the treating step comprises adding an ammonia solution into the precursor mixture so that co-precipitation of Fe₃O₄ within the porous graphene structures occurs, thereby forming the Fe₃O₄/porous graphene composite; and treating the Fe₃O₄/porous graphene composite, after being filtrated and collected.

In certain embodiments, the nanoparticles comprise Pt, and the precursors of the Pt nanoparticles comprise H₂PtCl₆.6H₂O added into the dispersion of the porous graphene structures. In certain embodiments, the treating step comprises refluxing the precursor mixture so that Pt nanoparticles precipitate within the porous graphene structures, thereby forming the Pt/porous graphene composite, and drying the Pt/porous graphene composite, after being filtrated and collected.

In another aspect, the invention relates to a nannoparticle/porous graphene composite synthesized according to the above method.

In yet another aspect, the invention relates to an article comprising the nannoparticle/porous graphene composite synthesized according to the above method.

In certain embodiments, the article is an electrode usable for a battery or supercapacitor.

In one aspect of this invention, low-dimension nanoparticles are uniformly loaded onto nitrogen-doped mesoporous graphene fibers. In most cases, nanoparticles with electrochemical activity are always suffering from aggregations, particularly in some cases that require high-temperature synthesis processes. According to the invention, mesoporous graphene fibers are synthesized and show excellent performance in energy storages. In certain embodiments, the confined growth of LTO nanoparticles in the mesopores of nitrogen-doped mesoporous graphene fibers (NPGFs) to fabricate effective nanocomposite architecture for high-performance anode materials is performed. In the nanocomposite structure, active LTO nanoparticles grow uniformly in the matrix. In certain embodiments, the nitrogen-doped mesoporous graphene fibers not only provide a continuous conductive matrix for long-range conductivity, but also act as the host for the confined growth of nanosize LTO and prevent agglomerations of LTO during annealing. The interconnected pore networks of NPGFs also provide large surface areas for electrolyte transport. Therefore, based on the properties the composite is expected for durable performance of their batteries.

In certain aspects of the invention, to synthesize the composite, nitrogen-doped fibers are dispersed in to a solvent such as ethanol, and then precursors of active LTO nanoparticles are added into the dispersion of the nitrogen-doped fibers in the solvent. Based on the good absorbability of the fibers, the precursors dissolved in ethanol are fully adsorbed into the mesopores. It should be appreciated that the precursors of active nanoparticles are not limited to those of LTO, and other types of active nanoparticles including various metal oxides, metals, and inorganic compounds can also be utilized to practice this invention. Further, it should be appreciated that the exemplary examples of the invention use mesoporous graphene fibers (or nanofibers), and other mesoporous graphene structures such as mesoporous graphene tubes (or nanotubes), mesoporous graphene wires (or nanowires) can also be utilized to practice this invention.

After evaporating the solvent, the collected composite precursors are annealed to make the final composites, where LTO nanoparticles are uniformly grown into the pores of graphene fibers. Also, as the result of confined growth, the nanopartiles are in small sizes, which are less than 10 nanometers. Such composites have excellent properties for energy storage such as in lithium ion batteries.

It should also be noted that the described synthesis approach may be readily scaled up at low cost for large scale production, since the procedures are very easily operated.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 shows schematic procedures for synthesizing a nannoparticle/mesoporous graphene composite according to one embodiment of the invention.

FIG. 2 is a schematic illustration of the synthesis procedures to load active LTO nanoparticles onto nitrogen-doped mesoporous graphene fibers to prepare the nanocomposites according to one embodiment of the invention.

FIG. 3 shows a TEM image of LTO/nitrogen-doped mesoporous graphene fiber nanocomposites, showing that LTO nanoparticles are uniformly loaded onto the porous fibers, according to one embodiment of the invention.

FIG. 4 shows a TEM image of metal oxide/nitrogen-doped mesoporous graphene fiber nanocomposites, showing that oxide (Fe₃O₄) nanoparticles are uniformly loaded onto the porous fibers, according to one embodiment of the invention.

FIG. 5 shows charge/discharge capacities of LTO/nitrogen-doped mesoporous graphene fiber nanocomposite in comparison with pure LTO at various rates from 1 to 10 C at 1-2.8 V, according to one embodiment of the invention.

FIG. 6 shows cycling stability of LTO/ nitrogen-doped mesoporous graphene fiber nanocomposite electrode at the rate of 10 C. according to one embodiment of the invention.

### DESCRIPTION OF EMBODIMENTS

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term are the same, in the same context, whether or not it is highlighted. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items. As used herein, the singular forms “a”, “an” and “the” are intended to include the plural forms as well, unless the context clearly indicates otherwise.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Furthermore, relative terms, such as “lower” or “bottom” and “upper” or “top”, may be used herein to describe one element's relationship to another element as illustrated in the figures. It will be understood that relative terms are intended to encompass different orientations of the device in addition to the orientation depicted in the figures. For example, if the device in one of the figures is turned over, elements described as being on the “lower” side of other elements would then be oriented on “upper” sides of the other elements. The exemplary term “lower” can, therefore, encompass both an orientation of “lower” and “upper”, depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

It will be further understood that the terms “comprise” or “comprising”, “include” or “including”, “carry” or “carrying”, “has/have” or “having”, “contain” or “containing”, “involve” or “involving” and the like are to be open-ended, i.e., to mean including but not limited to, and when used in the claims and specification specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about”, “substantially” or “approximately” shall generally mean within 20 percent, preferably within 10 percent, and more preferably within 5 percent of a given value or range. Numerical quantities given herein are approximate, meaning that the term “around”, “about”, “substantially” or “approximately” can be inferred if not expressly stated.

As used herein, the phrase “at least one of A, B, and C” should be construed to mean a logical (A or B or C), using a non-exclusive logical OR. It should be understood that one or more steps within a method may be executed in different order (or concurrently) without altering the principles of the invention.

The description is now made as to the embodiments of the invention in conjunction with the accompanying drawings. In accordance with the purposes of this invention, as embodied and broadly described herein, this invention relates to a method of loading active nanoparticles into porous graphene structures, and a resulted composite therefrom and applications of the same. The resulted composite provides excellent properties and has great potential in wide applications, such as in lithium-ion batteries and supercapacitors.

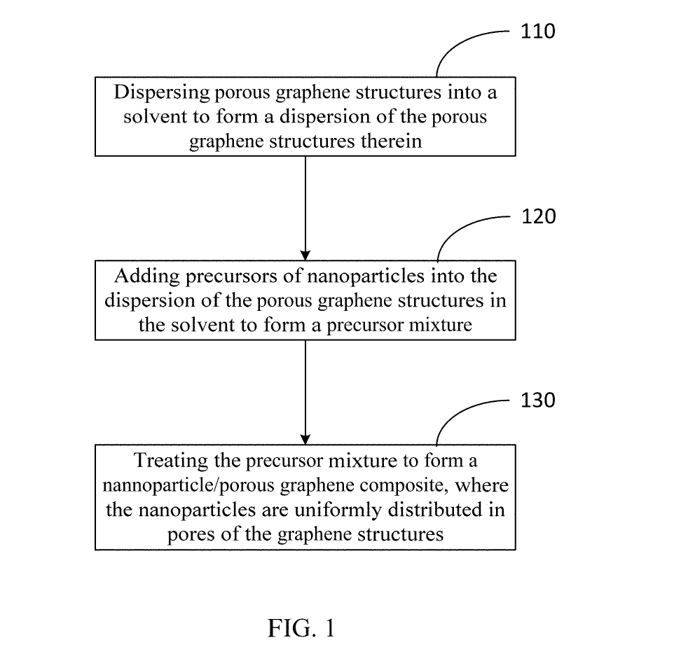

In one aspect, the invention relates to a method of synthesizing a nannoparticle/porous graphene composite. In one embodiment, as shown in FIG. 1, the method include the following steps.

At step 110, porous graphene structures are dispersed into a solvent to form a dispersion of the porous graphene structures therein.

In certain embodiment, the porous graphene structures comprise mesoporous graphene fibers, mesoporous graphene tubes, mesoporous graphene wires, or a combination of them. In certain embodiments, the mesoporous graphene fibers include nitrogen-doped graphene fibers.

In certain embodiments, the solvent comprises alcohol, water, or a combination of them. In certain embodiments, the solvent comprises ethanol, or ethylene glycol.

At step 120, precursors of nanoparticles are added into the dispersion of the porous graphene structures in the solvent to form a precursor mixture. In certain embodiments, the precursors dissolved in the solvent are adsorbed into the pores of the graphene structures. In certain embodiments, the precursors of the nanoparticles comprise metal oxides, metals, and/or inorganic compounds.

At step 130, the precursor mixture is treated to form a nannoparticle/porous graphene composite.

In certain embodiments, the composite is formed such that the nanoparticles are uniformly distributed in pores of the graphene structures. The nanopartiles are in sizes of less than 10 nanometers.

In certain embodiments, the nanoparticles comprise LTO, and the precursors of the LTO nanoparticles comprise lithium acetate, and tetra-n-butyltitanate added into the dispersion of the porous graphene structures.

In certain embodiments, the treating step includes evaporating the solvent to form the dried powders, and annealing the dried powders to form the nannoparticle/porous graphene composite.

In certain embodiments, the nanoparticles comprise F₃O₄, and the precursors of the F₃O₄ nanoparticles comprise FeCl₃ and FeCl₂.4H₂O added into the dispersion of the porous graphene structures.

In certain embodiments, the treating step comprises adding an ammonia solution into the precursor mixture so that co-precipitation of Fe₃O₄ within the porous graphene structures occurs, thereby forming the Fe₃O₄/porous graphene composite; and treating the Fe₃O₄/porous graphene composite, after being filtrated and collected.

In certain embodiments, the nanoparticles comprise Pt, and the precursors of the Pt nanoparticles comprise H₂PtCl₆.6H₂O added into the dispersion of the porous graphene structures.

In certain embodiments, the treating step comprises refluxing the precursor mixture so that Pt nanoparticles precipitate within the porous graphene structures, thereby forming the Pt/porous graphene composite, and drying the Pt/porous graphene composite, after being filtrated and collected.

In another aspect, the invention relates to a nannoparticle/porous graphene composite synthesized according to the above method.

In yet another aspect, the invention relates to an article comprising the nannoparticle/porous graphene composite synthesized according to the above method.

In certain embodiments, the article is an electrode usable for a battery or supercapacitor.

One aspect of the invention provides a method to load nanoparticle into nitrogen-doped mesoporous graphene fibers and the resulted composite structure. More specifically, hierarchically structured nanoparticle/nitrogen-doped porous graphene fiber nanocomposites are synthesized by using confined growth of functional nanoparticles in nitrogen-doped mesoporous graphene fibers. The graphene fibers with uniform pore structure are used as template for hosting precursors of active nanoparticles, followed by anneal treatment. The resulted composites have very uniform structure, since the nanoparticles are uniformly distributed in the fibers. The composites are very useful as electrode materials in electrochemical devices, in which efficient ion and electron transport is required.

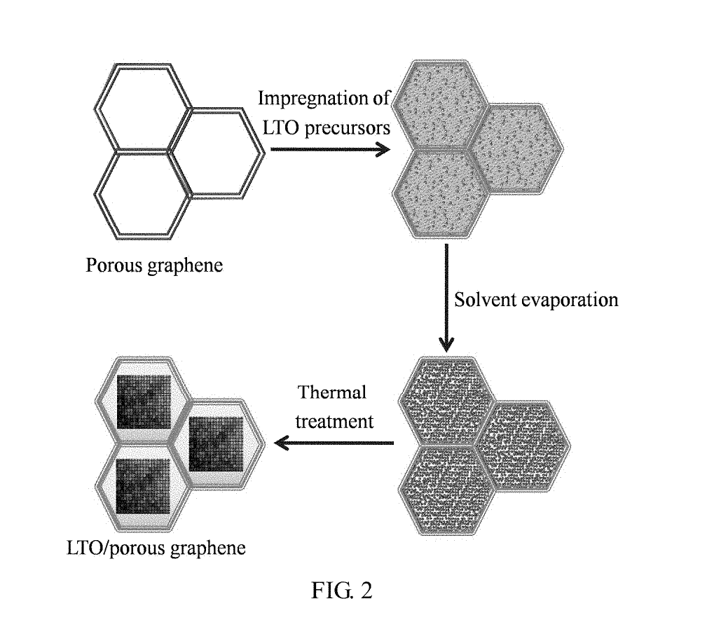

In one exemplary example, for the synthesis of LTO/nitrogen-doped mesoporous graphene fiber nanocomposite, about 20 mg of nitrogen-doped mesoporous graphene fibers was dispersed into about 10 mL of ethanol. Then, about 0.11 g of lithium acetate, and about 0.72 g of tetra-n-butyltitanate as the precursor of LTO were dissolved into the dispersion of nitrogen-doped mesoporous graphene fibers, thereby forming a precursor mixture. The mixture was treated to evaporate ethanol. After that, the collected dried powders were annealed to form the final LTO/nitrogen-doped mesoporous graphene fiber nanocomposites. In certain embodiment, as illustrated in FIG. 2, these procedures lead to formation of uniform composite, where LTO nanoparticle are uniformly loaded into nitrogen-doped mesoporous graphene fibers.

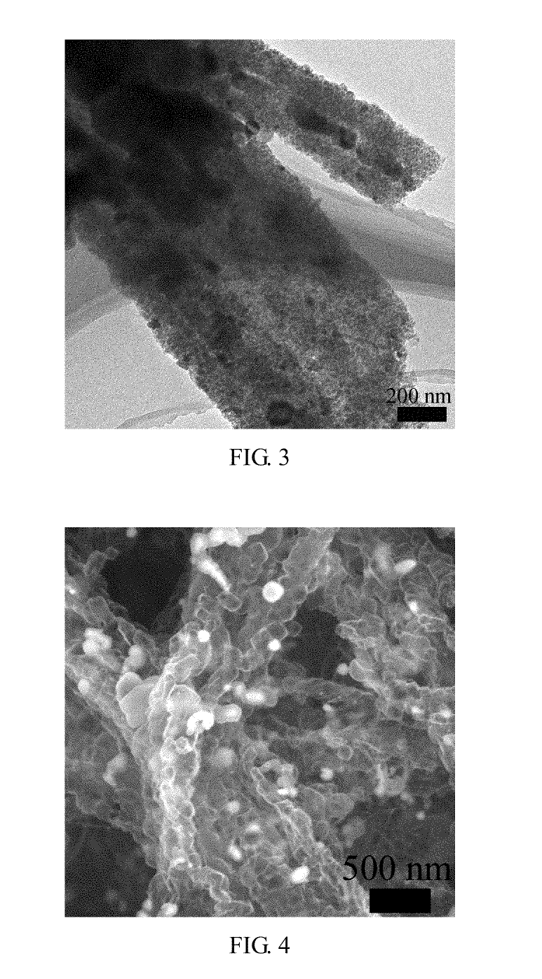

The morphology of as-prepared composites was first investigated using electron microscopy techniques. As shown in FIG. 3, transmission electron microscopeimage of the composites displayed that the nanocomposites displayed fiber shape, with a uniform texture. It showed that LTO nanoparticles with sizes around several nanometers were visible in the mesopores of the fibers. They were not coated on the outside surfaces of the fibers. The results showed that LTO nanoparticles are grown within the fibers due to the high wettablity of the porous matrix. Such composite structure forms direct interfacial contact between the fibers and LTO components, enhancing the charge transport for energy storage.

It is very important to point out that, the synthesis procedure of this invention have wide applications in composite synthesis. The type of the nanoparticles is not limited to LTO, and can be others. The inventor also uses the porous graphene fiber to load metal oxides to demonstrate the wide applications of the synthesis route. For example, in a typical synthesis of the Fe₃O₄/porous graphene fiber composite, about 0.5 g of nitrogen-doped mesoporous graphene fiber was dispersed in about 300 mL alcohol-water (1:2, v/v) solution, into which were then added about 1.82 g of FeCl₃ and about 1.11 of FeCl₂.4H₂O. After adding about 12 mL of 28 wt % aqueous ammonia solution, co-precipitation of Fe₃O₄ within the porous fibers occurred, which produce a Fe₃O₄/porous graphene fiber composite. As shown in FIG. 4, Fe₃O₄ particles in a size of about 8 nanometers are obtained.

Samples of the prepared hierarchically structured oxide/porous graphene fiber composite according to the invention were subjected to electrochemical testing as now described. To prepare the electrodes, about 80 wt % of the composite, about 10 wt % of carbon black, and about 10 wt % of polyvinylidene fluoride (PVDF) were mixed with 1-methyl-2-pyrrolidinone (NMP) to form uniform slurries. The slurries were coated on copper substrates and dried under vacuum. To test the electrochemical performance, the electrodes were then assembled into 2015-type coin cells, where lithium foils were used as both the counter and reference electrodes and glass fibers (Whatman) were used as the separators. The electrolyte solution was about 1 mol L⁻¹ LiPF₆ in ethylene carbonate (EC)/diethyl carbonate (DEC) (1:1 by volume) solution. Galvanostaic charge/discharge measurements were carried out by a LAND CT2000 battery tester at various current densities.

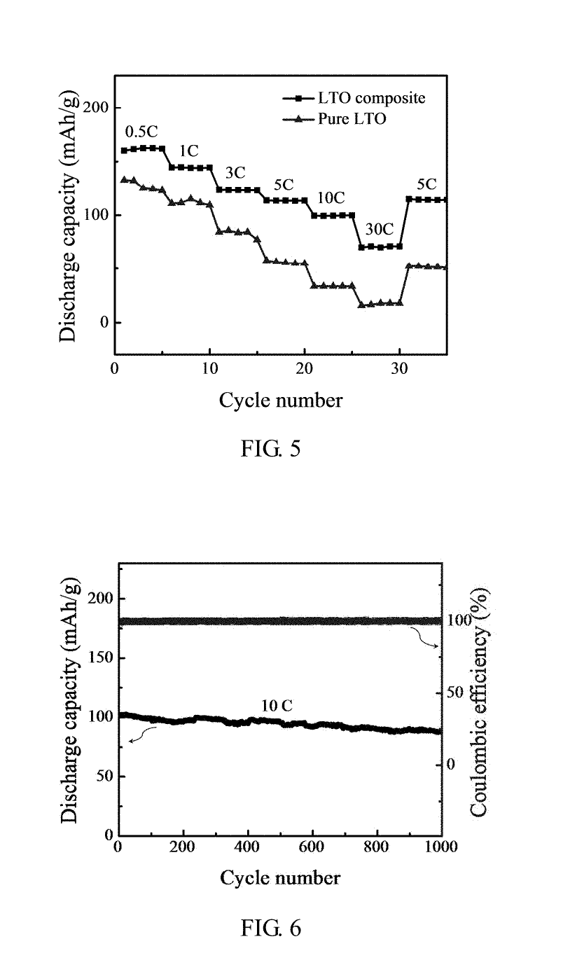

FIG. 5 shows galvanostatic charge/discharge profiles of the electrode made from LTO/nitrogen-doped mesoporous graphene fiber composite between about 1.0 and about 2.8 V vs Li⁺/Li at the rates of about 0.5-30 C. The composite of the electrode delivered reversible discharge capacities of about 160, 145, 123, 114 and 100 mAh g⁻¹ at the rates of about 0.5, 1, 3, 5 and 10 C. Even at a high rate of about 30 C, the composite capacity still approached about 72 mAh g⁻¹. The rate performance is much better than that of electrode made from pure LTO. The results suggest the effectiveness of confined growth of small nanoparticles in porous graphene fibers. Moreover, long-term cycling stability of the electrode were charged and discharged at the rate of about 10 C (shown FIG. 6), which displayed a capacity retention of about 89.5% after about 1000 cycles, suggesting a durable performance.

Without intent to limit the scope of the invention, examples and their related results according to the embodiments of the present invention are given below.

### EXAMPLE 1

This exemplary example provides a method to synthesize LTO/nitrogen-doped mesoporous graphene fibers. The synthesizing process according to one embodiment of the invention is detailed as follows.

(1) About 20 mg of nitrogen-doped mesoporous graphene fibers was dispersed into about 10 mL of ethanol to form a uniform dispersion; then, a precursor of LTO including about 0.11 g of lithium acetate, and about 0.72 g of tetra-n-butyltitanate were dissolved into the dispersion of nitrogen-doped mesoporous graphene fibers, thereby forming a precursor mixture.

(2) The precursor mixture was treated to evaporate the ethanol.

(3) After the treatment, the collected dried powders were annealed at temperature about 800° C. under a flow of argon, to form the final LTO/nitrogen-doped mesoporous graphene fiber composite.

The TEM image of LTO/nitrogen-doped mesoporous graphene fiber nanocomposites shown in FIG. 3 shows that LTO nanoparticles are uniformly loaded onto the porous fibers.

### EXAMPLE 2

This example provides a method to synthesize Fe₃O₄/nitrogen-doped mesoporous graphene fibers. The synthesizing process according to one embodiment of the invention is detailed as follows.

(1) About 0.5 g of nitrogen-doped mesoporous graphene fiber was dispersed in about 300 mL alcohol-water (1:2, v/v) solution, into which were then added about 1.82 g of FeCl₃ and about 1.11 of FeCl₂.4H₂O as the precursors of F₃O₄ nanoparticles.

(2) After adding about 12 mL of about 28 wt % aqueous ammonia solution, co-precipitation of Fe₃O₄ within the porous fibers occurred, which produces Fe₃O₄/porous graphene fiber composite. After being filtrated, Fe₃O₄/porous graphene fiber composites were collected.

(3) The collected Fe₃O₄/porous graphene fiber composites were then treated at about 300° C. under a flow of nitrogen, to form the final Fe₃O₄/nitrogen-doped mesoporous graphene fiber composite.

The TEM image of metal oxide/nitrogen-doped mesoporous graphene fiber nanocomposites shown in FIG. 4 shows that oxide (Fe₃O₄) nanoparticles are uniformly loaded onto the porous fibers.

### EXAMPLE 3

This example provides a method to synthesize Pt/nitrogen-doped mesoporous graphene fibers. The synthesizing process according to one embodiment of the invention is detailed as follows.

(1) About 0.1 g of nitrogen-doped mesoporous graphene fiber was dispersed in about 300 mL ethylene glycol solution, into which were then added about 0.1 g H₂PtCl₆.6H₂O as a Pt catalyst precursor. Ethylene glycol act as the solvent to disperse the graphene fibers and also as a reducing agent for Pt nanoparticles.

(2) The mixture dispersion was then refluxed at about 130° C. for about 6 hours. After that, Pt nanoparticles precipitate with a high-density within nitrogen-doped mesoporous graphene fibers.

(3) After being filtrated, Pt/porous graphene fiber composites were collected, and dried at about 160° C. under a flow of argon.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method of synthesizing a nannoparticle/porous graphene composite, comprising:
dispersing porous graphene structures into a solvent to form a dispersion of the porous graphene structures therein;
adding precursors of nanoparticles into the dispersion of the porous graphene structures in the solvent to form a precursor mixture; and
treating the precursor mixture to form a nannoparticle/porous graphene composite, where the nanoparticles are uniformly distributed in pores of the graphene structures.

2. The method of claim 1, wherein the nanopartiles are in sizes of less than 10 nanometers.

3. The method of claim 1, wherein the porous graphene structures comprise mesoporous graphene fibers, mesoporous graphene tubes, mesoporous graphene wires, or a combination of them.

4. The method of claim 3, wherein the mesoporous graphene fibers comprise nitrogen-doped graphene fibers.

5. The method of claim 1, wherein the solvent comprises alcohol, water, or a combination of them.

6. The method of claim 5, wherein the solvent comprises ethanol, or ethylene glycol.

7. The method of claim 1, wherein the precursors dissolved in the solvent are adsorbed into the pores of the porous graphene structures.

8. The method of claim 1, wherein the precursors of the nanoparticles comprise metal oxides, metals, and/or inorganic compounds.

9. The method of claim 8, wherein the nanoparticles comprise Li₄Ti₅O₁₂ (LTO), and the precursors of the LTO nanoparticles comprise lithium acetate, and tetra-n-butyltitanate added into the dispersion of the porous graphene structures.

10. The method of claim 9, wherein the treating step comprises
evaporating the solvent to form the dried powders; and
annealing the dried powders to form the nannoparticle/porous graphene composite.

11. The method of claim 8, wherein the nanoparticles comprise F₃O₄, and the precursors of the F₃O₄ nanoparticles comprise FeCl₃ and FeCl₂.4H₂O added into the dispersion of the porous graphene structures.

12. The method of claim 11, wherein the treating step comprises
adding an ammonia solution into the precursor mixture so that co-precipitation of Fe₃O₄ within the porous fibers occurs, thereby forming the Fe₃O₄/porous graphene composite; and
treating the Fe₃O₄/porous graphene composite, after being filtrated and collected.

13. The method of claim 8, wherein the nanoparticles comprise Pt, and the precursors of the Pt nanoparticles comprise H₂PtCl₆.6H₂O added into the dispersion of the porous graphene structures.

14. The method of claim 13, wherein the treating step comprises
refluxing the precursor mixture so that Pt nanoparticles precipitate within the porous graphene structures, thereby forming the Pt/porous graphene composite; and
drying the Pt/porous graphene composite, after being filtrated and collected.

15. A nannoparticle/porous graphene composite synthesized according to claim

16. An article, comprising the nannoparticle/porous graphene composite synthesized according to claim 1.

17. The article of claim 16, being an electrode usable for a battery or supercapacitor.
